(19) United States
(12) Patent Application Publication
(10) Pub. No.: US 2019/0120774 A1
(43) Pub. Date: Apr. 25, 2019

(54) VEHICLE SEAT INSPECTION SYSTEM

(71) Applicant: FORD GLOBAL TECHNOLOGIES, LLC, Dearborn, MI (US)

(72) Inventors: Michael James WHITENS, Novi, MI (US); Dragos MACIUCA, Mountain View, CA (US); Dennis LIU, Irvine, CA (US); Hyung Min BAEK, Sunnyvale, CA (US); Aaron HALONEN, Brighton, MI (US); Carlo CASCIANELLI, Sterling Heights, MI (US); Michael M. FILIPOVICH, West Bloomfield, MI (US); Phillip Kerry MULDOWNEY, Brighton, MI (US)

(21) Appl. No.: 15/793,500

(22) Filed: Oct. 25, 2017

(51) Int. Cl. G01N 21/95; G01N 21/88

(52) U.S. Cl. CPC G01N 21/9515; B60N 2/5891; G01N 2021/8864; G01N 21/8806

(57) ABSTRACT

An inspection station includes a conveyor, an imaging device, and a controller. The conveyor is configured to transfer a vehicle seat into the station. The imaging device is configured to capture three-dimensional data of the vehicle seat while in the station. The controller is programmed to, responsive to a deviation of the three-dimensional data from a baseline model of the seat being greater than a threshold, direct the vehicle seat to a repair station via the conveyor.

### TECHNICAL FIELD

The disclosure relates to an inspection system for vehicle seats.

### BACKGROUND

Vehicle seats may be produced in a production plant and then shipped to a separate final assembly plant where the seats are then incorporated into vehicles.

### SUMMARY

An inspection station includes a conveyor, an imaging device, and a controller. The conveyor is configured to transfer a vehicle seat into the station. The imaging device is configured to capture three-dimensional data of the vehicle seat while in the station. The controller is programmed to, responsive to a deviation of the three-dimensional data from a baseline model of the seat being greater than a threshold, direct the vehicle seat to a repair station via the conveyor.

A system includes an imaging device, a monitor, and a controller. The imaging device is configured to capture three-dimensional data of a vehicle seat. The controller is programmed to, responsive to a deviation of the three-dimensional data from a baseline model of the seat being greater than a threshold, operate the monitor to display a captured model of the seat based on the three-dimensional data and to illustrate defects in the seat relative to the baseline model and based on the deviation.

A method includes transporting a vehicle seat into an inspection station via a conveyor, capturing three-dimensional data of the seat via an imaging device in the inspection station, directing the seat into a repair station via the conveyor in response to a deviation of the three-dimensional data from a baseline model of the seat being greater than a threshold, and displaying defects in the seat relative to the baseline model and based on the deviation.

### BRIEF DESCRIPTION OF THE DRAWINGS

FIG. 1 is a flowchart illustrating a method of producing vehicle seats;

FIG. 2 is a schematic illustration of a vehicle seat inspection station;

FIG. 3 is flowchart illustrating a method of inspecting vehicle seats; and

FIG. 4 is an illustration of a vehicle seat.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

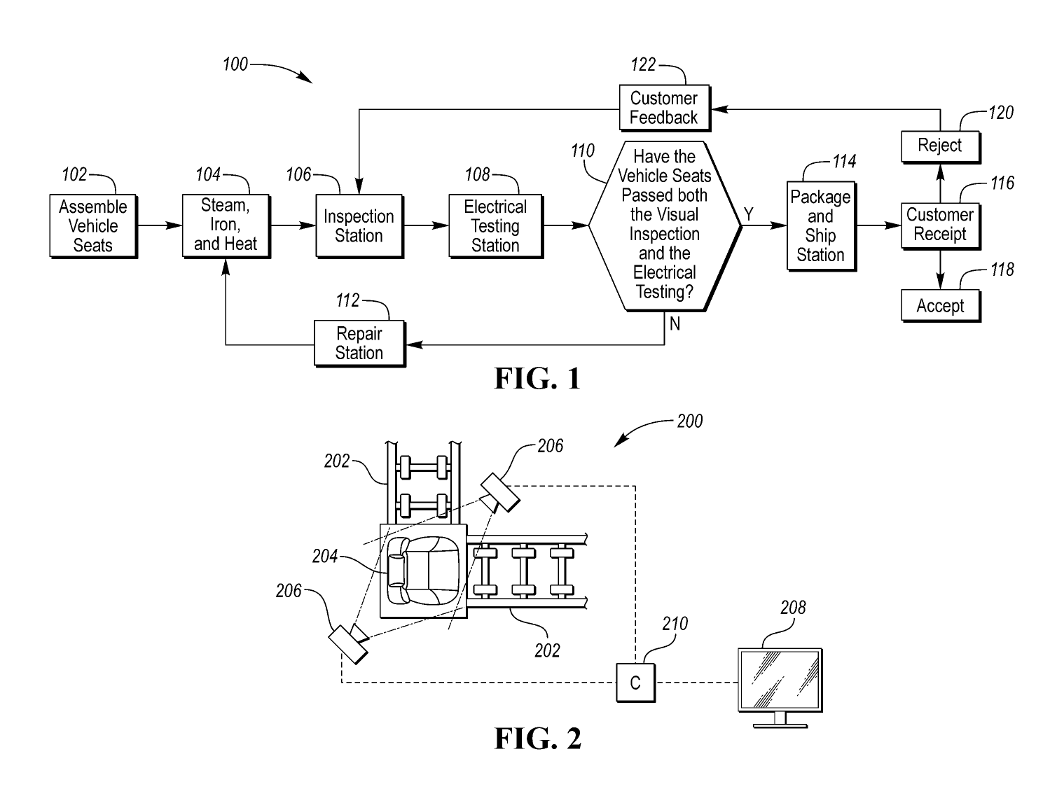

Referring to FIG. 1, a flowchart of a method 100 of producing vehicles seats is illustrated. The method 100 begins at block 102 where the vehicle seats are assembled. This may include assembling seat bottoms and seatbacks followed by mating the seat bottoms to the seatbacks. Various padding components, such as seat cushions or seatback cushions which may be made from a foam or other padding material, may be secured to framing components of the seat bottoms and seatbacks. An exterior material layer may be then secured over the various padding components and/or any exposed framing components of the seat bottoms and seatbacks. The exterior material layer may be secured to the seat bottoms and seatbacks by fasteners, adhesives, or by a stitching process. The exterior material layer may be made from a thin layer of cloth, fabric (natural or synthetic), leather, or any other material known in the art that may be used to construct the exterior material layer of the vehicles seats. The exterior material layer may consist of multiple sections that are secured to each other by a tucking process, a stitching process, or any other process known in the art that may be used to secured adjacent sections of cloth, fabric, leather, etc. to each other. A headrest, electronic controls for an adjustment mechanism of the vehicle seat, armrests, and various other components (e.g., miscellaneous plastic trim components) may be secured to the seat bottom and/or seatback during the assembly process at block 102.

Once the vehicle seats have been assembled, the method 100 moves on to block 104 where the exterior material layers of the vehicle seats are steamed, ironed, and heated in an oven. The vehicle seats are first steamed and ironed in order to remove any wrinkles in the exterior material layers. Once the vehicle seats are steamed and ironed, the vehicle seats may be transferred into an oven (e.g., an infrared oven) where any excess moisture that may have been introduced during the steaming and ironing process is removed from the seats. Heating the vehicle seats may also act to relax the exterior materials if any stresses were introduced during assembly at block 102. Once the seats have been steamed, ironed, and heated, the build process of the seats is considered to be complete.

Once the build process is complete, the method 100 moves on to an automated visual inspection station at block 106 where the exteriors of the vehicle seats are visually inspected for any defects. At block 106, the vehicle seats will either pass or fail the visual inspection. Additionally, an electronic record of the seat inspection (images, data comparisons, etc.) is created and stored for future data analysis and reporting. If the vehicle seats fail the inspection, the vehicle seats will be flagged for repair. After the exterior of the vehicle seats have been inspected, the method 100 moves on to an automated electrical testing station at block 108 where the electrical systems of the vehicle seats are tested. The electrical systems of the vehicle seats may include seat position adjustment systems, heating systems, cooling systems, buckles, side airbags, features such as lumbar supports, etc. At block 108, the vehicle seats will either pass or fail the electrical testing. If the vehicle seats fail the electrical testing, the vehicle seats will be flagged for repair.

Once electrical testing is complete at block 108, the method 100 moves on to block 110 where is determined if the vehicle seats have passed both the visual inspection at block 106 and the electrical testing at block 108. If the vehicle seats have not passed both the visual inspection and the electrical testing, the method 100 moves on to a repair station at block 112 where any defects in the vehicle seats may be repaired. Once the vehicle seats have been repaired the method returns to block 104. If the vehicle seats have passed both the visual inspection and the electrical testing, the method moves on to a package and ship station at block 114 where the vehicle seats are packaged and shipped to a customer at a final assembly plant. It should be noted that the vehicle seats may be transported to the various stations 102-114 by conveyor or conveyance system. It should also be noted that a human inspector may be positioned after the electrical testing station at block 108 and may have the authority to override any automated failure of the vehicle seats that may have occurred either in the visual inspection station at block 106 and/or the electrical testing station at block 108. If a human inspector overrides any automated failure of the vehicle seats, the method 100 would create a record of the event and directly proceed from block 108 to block 114.

Once the vehicle seats have been packaged and shipped to the customer at the final assembly plant at block 114, the customer will receive vehicle seats at block 116. Once the customer receives vehicle seats at block 116, the customer will either accept the vehicle seats at block 118 or reject the vehicle seats at block 120 (e.g., due to a defect). If the customer rejects the vehicle seats at block 120, information in the form of customer feedback 122 is delivered to the automated inspection station at block 106 regarding any defects that resulting in the rejection. The customer feedback 122 may also be delivered to a human inspector that is positioned after the electrical testing station at block 108. The customer feedback 122 may be utilized to update the automated inspection station at block 106 in order to reconfigure the automated inspection station such that vehicle seats having similar defects will fail future inspections. It should be understood that the flowchart in FIG. 1 is for illustrative purposes only and that the method 100 should not be construed as limited to the flowchart in FIG. 1. Some of the steps of the method 100 may be rearranged while others may be omitted entirely.

Referring to FIG. 2, an automated vehicle seat inspection station (or automated vehicle seat inspection system) 200 is illustrated. The seat inspection station 200 may be the automated inspection station positioned at block 106 in FIG. 1. The seat inspection station 200 includes a conveyor 202 that is configured to transfer a vehicle seat 204 into and out of the seat inspection station 200. The seat inspection station 200 includes at least one imaging device 206 that is configured to capture three-dimensional data of the vehicle seat 204 while the vehicle seat 204 is in the seat inspection station 200. This inspection station 200 may include a monitor 208. The at least one imaging device 206 and the monitor 208 may each be in communication with a controller 210. Although the automated vehicle seat inspection station 200 is shown to be positioned along a corner of the conveyor 202, it should be understood that the automated vehicle seat inspection station 200 may be positioned at any location along the conveyor 202, including along a straight section of the conveyor.

While illustrated as one controller, the controller 210 may be part of a larger control system and may be controlled by various other controllers throughout the inspection station 200 or any of the other stations or structural components that perform the steps listed in FIG. 1. It should therefore be understood that the controller 210 and one or more other controllers can collectively be referred to as a “controller” that controls various actuators in response to signals from various sensors to control various functions. The controller 210 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 210.

Control logic or functions performed by the controller 210 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 210. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer. The computer-readable storage devices or media may include one or more of a number of known physical devices which utilize electric, magnetic, and/or optical storage to keep executable instructions and associated calibration information, operating variables, and the like.

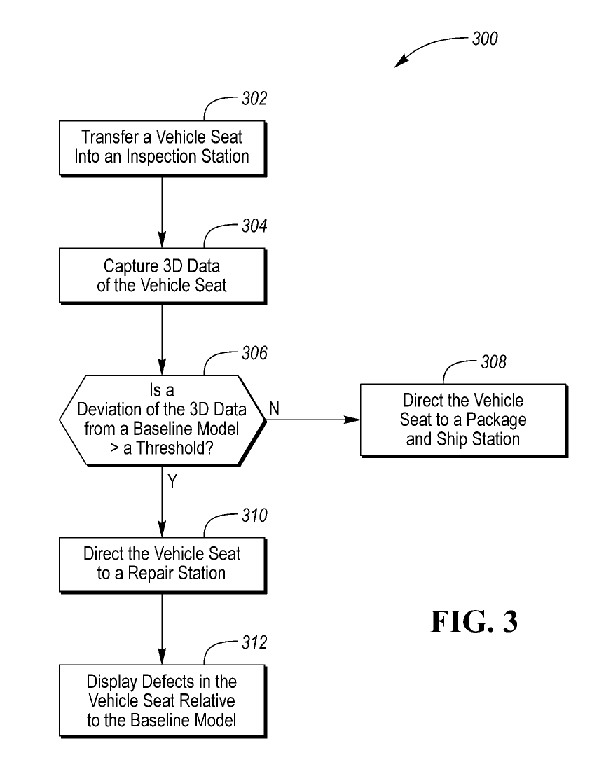

Referring to FIG. 3, a flowchart of a method 300 of inspecting vehicle seats is illustrated. The method 300 may be stored as an algorithm and/or control logic within the controller 210. The controller 210 may be configured to implement the method 300 based on various states or conditions of the inspection station 200 or any of the other stations or structural components that perform the steps listed in FIG. 1. The method 300 begins at block 302 where a vehicle seat (e.g., vehicle seat 204) is transferred into an inspection station (e.g., inspection station 200). Once the vehicle seat is in the inspection station, three-dimensional data of the vehicle seat is captured at block 304. The three-dimensional data may be captured by one or more imaging devices (e.g., imaging device 206). The imaging device may be a three-dimensional scanner, stereo camera, light-field camera (also referred to as a plenoptic camera), infrared laser, or any other device known in the art that is capable of capturing three-dimensional images of a physical object. When multiple imaging devices are utilized, they generate point clouds resulting three-dimensional that is representative of a vehicle seat.

Once the three-dimensional data of the vehicle seat is captured at block 304, the method moves on to block 306 where it is determined if a deviation of the three-dimensional data from a baseline three-dimensional model of the vehicle seat is greater than a threshold. Alternatively stated, it is determined at block 306 if any deviations from desired geometrical dimensions or parameters of the vehicle seat are within tolerable ranges. If the deviation of the three-dimensional data from the baseline model is less than the threshold, the method 300 moves on to block 308 where the vehicle seat is directed to a package and ship station (e.g., package and ship station at block 114 in FIG. 1) via a conveyance system (e.g., conveyor 202). If the deviation of the three-dimensional data from the baseline model is greater than the threshold, the method 300 moves on to blocks 310 and 312. The three-dimensional data and the results at decision at block 306 may be recorded and utilize to for future inspections.

At block 310 the vehicle seat is directed to a repair station (e.g., repair station at block 112 in FIG. 1). At block 312 defects in the vehicle seat relative to the baseline model are displayed. More specifically at block 312, a monitor (e.g., monitor 208) may be operated to display a captured three-dimensional model of the vehicle seat based on the three-dimensional data captured at block 304 by the imaging device, and to illustrate the defects in the vehicle seat relative to the baseline model based on the deviation of the three-dimensional data from the baseline model. The threshold at block 306 for determining whether to send the vehicle seat to either the repair station at block 310 or the package and ship station at block 308 may be adjusted by a machine-learning algorithm that accounts for previously and newly captured three-dimensional data of multiple vehicle seats that have either passed or failed visual inspection. It should be understood that the flowchart in FIG. 3 is for illustrative purposes only and that the method 300 should not be construed as limited to the flowchart in FIG. 3. Some of the steps of the method 300 may be rearranged while others may be omitted entirely.

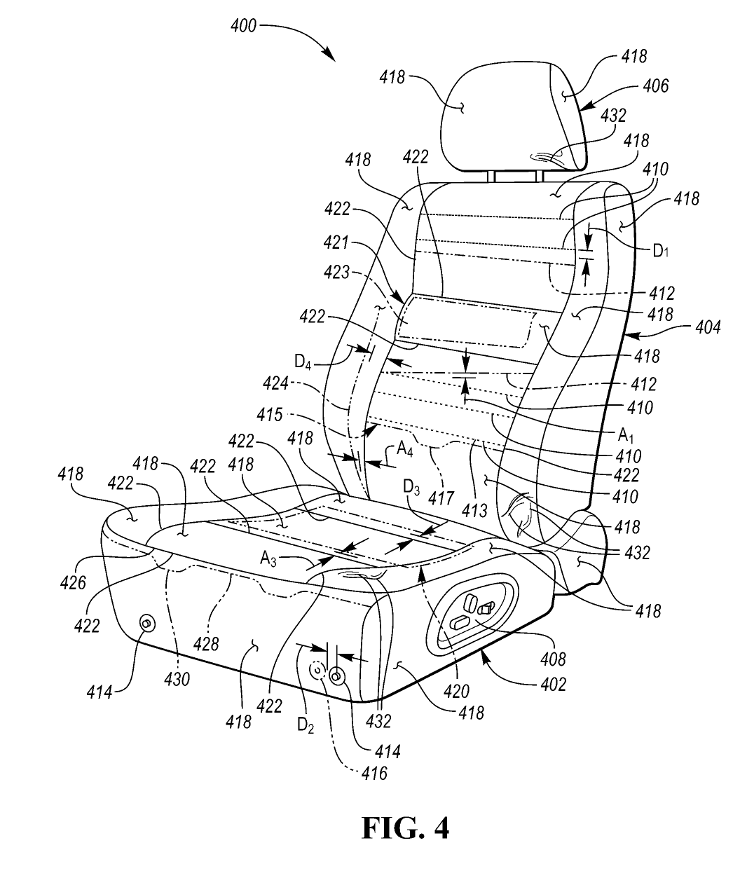

Referring to FIG. 4, a vehicle seat 400 is illustrated. The vehicle seat 400 includes a seat bottom 402, a seatback 404, a headrest 406, and a control panel 408. The control panel 408 may include a user interface, such as buttons, for adjusting the position of the seat 400 and/or adjusting a heating/cooling system of the seat 400. Common defects of the vehicle seat 400 that may result during the production process are demonstrated in FIG. 4. The defects of the seat 400 may be detected by the at least one imaging device 206 and stored as part of the three-dimensional data collected by the at least one imaging device 206 while the seat 400 is in the seat inspection station 200. The controller 210 is program to direct the seat 400 to the repair station in block 112 when the defects result in a deviation of the three-dimensional data from a baseline model of the seat 400 being greater than a threshold. If the deviation of the three-dimensional data from the baseline model of the seat 400 is less than the threshold, the controller 210 is program to direct the seat 400 to the package and ship station at block 114.

The three-dimensional data may include captured positions of stitching patterns 410 on the seat 400. The baseline model of the seat 400 may include a desired position of the stitching pattern 412. The threshold of the deviation of the three-dimensional data from the baseline model may correspond to a tolerable dimensional difference between the captured positions of stitching patterns 410 and the desired position of the stitching pattern 412. For example, the threshold may be a positional distance D₁ or an angular deviation A₁ from the desired position of the stitching pattern 412. The three-dimensional data may further include a desired profile 413 of the particular stitching patterns while the threshold may correspond to a tolerable dimensional difference between captured profiles 415 and the desired profiles 413. An example of a stitching pattern that deviates from a tolerable dimensional difference may be a stitching pattern that includes a bump 417 that deviates from a tolerable dimensional difference by a threshold distance from the desired profile 413 or a seam that includes an excess number of bumps.

The three-dimensional data may include captured positions of fasteners 414 on the seat 400. The baseline model of the seat 400 may include a desired position of the fasteners 416. The threshold of the deviation of the three-dimensional data from the baseline model may correspond to a tolerable dimensional difference between the captured positions of fasteners 414 and the desired position of the fasteners 416. For example, the threshold may be positional a distance D₂ from the desired position of the fasteners 414.

The three-dimensional data may include captured positions of fabric sections 418 on the exterior of the seat 400. The baseline model of the seat 400 may include a desired position of the fabric sections 420. The threshold of the deviation of the three-dimensional data from the baseline model may correspond to a tolerable dimensional difference between the captured positions of the fabric sections 418 and the desired positions of the fabric sections 420. For example, the threshold may be a positional distance D₃ or angular deviation A₃ from the desired position of the fabric sections 420. The three-dimensional data may also include desired geometric shapes 421 (or desired concave or convex profiles) of the particular fabric sections while the threshold may correspond to a tolerable dimensional difference between captured geometric shapes 423 (or captured concave or convex profiles) and the desired geometric shapes 421 (or desired concave or convex profiles).

The three-dimensional data may include captured positions of seams 422 on the seat 400. The baseline model of the seat 400 may include a desired position of the seams 424. The threshold of the deviation of the three-dimensional data from the baseline model may correspond to a tolerable dimensional difference between the captured positions of the seams 422 and the desired position of the seams 424. For example, the threshold may be a positional distance D₄ or an angular deviation A₄ from the desired position of the seams 424. The three-dimensional data may also include desired depths of the particular seams (which may be referred to puckers where multiple seams intersect) while the threshold may correspond to a tolerable dimensional difference between captured depths and the desired depths. The three-dimensional data may further include a desired profile 426 of the particular seams while the threshold may correspond to a tolerable dimensional difference between captured profiles 428 and the desired profile 426. An example a seam that deviates from a tolerable dimensional difference may be a seam that includes a bump 430 that deviates from a tolerable dimensional difference by a threshold distance from the desired profile 426 or a seam that includes an excess number of bumps.

The three-dimensional data may include captured positions of wrinkles 432 in the fabric sections 418 on the exterior of the seat 400. In the baseline model of the seat 400 it may be desirable not to includes wrinkles in the fabric sections 418. The threshold of the deviation of the three-dimensional data from the baseline model may correspond to tolerable dimensions of the wrinkles 432. For example, the tolerable dimensions of the wrinkles 432 may correspond to tolerable lengths, widths, heights, and/or depths. The threshold of the deviation of the three-dimensional data from the baseline model may also correspond to an allowable quantity of wrinkles within a particular area of the fabric sections 418.

Other deviations in the three-dimensional data from the baseline model that may result in the controller 210 directing the seat 400 to the repair station in block 112 may include, but are not limited to, the presence or absence of a feature (such as the headrest 406, buckle, belt, the control panel 408, buttons or switches of any electrical system, a fastener, a seam, a stitching pattern, plastic trim components such as foot covers, etc.), incorrect color patterns of seat components (e.g., plastic trim components, fabric sections, leather sections, threading, stitching, etc.), incorrect content (e.g., is the rear map pocket not present, does the particular model require manual or electrical adjustment mechanisms, is the seat belt or buckle twisted or mounted in an incorrect position, is the headrest backwards, are child seat tethers not present, etc.), scuffs or marring of any exterior surfaces, stains on exterior surfaces (e.g., soiling, oil, pen marks, etc.), fit and finish defects (e.g., gaps between plastic or trim components), margin/flush defects between components, incorrect position of a wire harness, incorrect dimensions regarding surface contours (effect on comfort), or misalignment of seams exceeding a tolerable dimensional threshold. Furthermore, it should be understood that the captured and desired features of the seat 400 described above may be exaggerated or rearranged for illustrative purposes and therefore should not be construed as limiting.

A redundant inspection system could also be implemented in a customer receiving facility. The redundant system could utilize similar inspection equipment and acceptance/rejection parameters to check inbound seats for shipping/rack damage.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

1. An inspection station comprising:
a conveyor configured to transfer a vehicle seat into the station;
an imaging device configured to capture three-dimensional data of the vehicle seat while in the station; and
a controller programmed to, responsive to a deviation of the three-dimensional data from a baseline model of the seat being greater than a threshold, direct the vehicle seat to a repair station via the conveyor.

2. The station of claim 1, wherein the controller is further programmed to, responsive to the deviation being less than the threshold, direct the vehicle seat to a package and ship station via the conveyor.

3. The station of claim 1, wherein the three-dimensional data includes a captured position of a stitching pattern on the vehicle seat, the baseline model includes a desired position of the stitching pattern, and the threshold corresponds to a tolerable dimensional difference between the captured and desired positions.

4. The station of claim 1, wherein the three-dimensional data includes a captured position of a fastener on the vehicle seat, the baseline model includes a desired position of the fastener, and the threshold corresponds to a tolerable dimensional difference between the captured and desired positions.

5. The station of claim 1, wherein the three-dimensional data includes a captured position of a seam between fabric sections on an exterior of the vehicle seat, the baseline model includes a desired position of the seam, and the threshold corresponds to a tolerable dimensional difference between the captured and desired positions.

6. The station of claim 1, wherein the three-dimensional data includes a captured position of a fabric section on an exterior of the vehicle seat, the baseline model includes a desired position of the fabric section, and the threshold corresponds to a tolerable dimensional difference between the captured and desired positions.

7. The station of claim 1, wherein the three-dimensional data includes a captured geometrical shape of a fabric section on an exterior of the vehicle seat, the baseline model includes a desired geometrical shape of the fabric section, and the threshold corresponds to a tolerable dimensional difference between the captured and desired shapes.

8. The station of claim 1, wherein the controller is further programmed to, responsive to an absence of a feature of the baseline model in the three-dimensional data, direct the vehicle seat to a repair station via the conveyor.

9. The station of claim 1, wherein the three-dimensional data includes a captured wrinkle in a fabric section on an exterior of the vehicle seat, the baseline model does not include wrinkle, and the threshold corresponds to a tolerable dimension of the wrinkle.

10. The station of claim 1, wherein the threshold is adjusted via a learning algorithm based on captured three-dimensional data of multiple vehicle seats.

11. A system comprising:
an imaging device configured to capture three-dimensional data of a vehicle seat;
a monitor; and
a controller programmed to, responsive to a deviation of the three-dimensional data from a baseline model of the seat being greater than a threshold, operate the monitor to display a captured model of the seat based on the three-dimensional data and to illustrate defects in the seat relative to the baseline model and based on the deviation.

12. The system of claim 11 further comprising a conveyor configured to transport the vehicle seat, and wherein the controller is further programmed to, responsive to the deviation being greater than the threshold, direct the vehicle seat to a repair station via the conveyor.

13. The system of claim 12, wherein the controller is further programmed to, responsive to the deviation being less than the threshold, direct the vehicle seat to a package and ship station via the conveyor.

14. The system of claim 11, wherein the three-dimensional data includes a captured position of a stitching pattern on the vehicle seat, the baseline model includes a desired position of the stitching pattern, and the threshold corresponds to a tolerable dimensional difference between the captured and desired positions.

15. The system of claim 11, wherein the three-dimensional data includes a captured position of a fastener on the vehicle seat, the baseline model includes a desired position of the fastener, and the threshold corresponds to a tolerable dimensional difference between the captured and desired positions.

16. The system of claim 11, wherein the three-dimensional data includes a captured position of a seam between fabric sections on an exterior of the vehicle seat, the baseline model includes a desired position of the seam, and the threshold corresponds to a tolerable dimensional difference between the captured and desired positions.

17. The system of claim 11, wherein the three-dimensional data includes a captured position of a fabric section on an exterior of the vehicle seat, the baseline model includes a desired position of a fabric section, and the threshold corresponds to a tolerable dimensional difference between the captured and desired positions.

18. The system of claim 11, wherein the three-dimensional data includes a captured wrinkle in a fabric section on an exterior of the vehicle seat, the baseline model does not include wrinkle, and the threshold corresponds to a tolerable dimension of the wrinkle.

19. The system of claim 11, wherein the threshold is adjusted via a learning algorithm based on captured three-dimensional data of multiple vehicle seats.

20. A method comprising:
transporting a vehicle seat into an inspection station via a conveyor;
capturing three-dimensional data of the seat via an imaging device in the inspection station;
directing the seat into a repair station via the conveyor in response to a deviation of the three-dimensional data from a baseline model of the seat being greater than a threshold; and
displaying defects in the seat relative to the baseline model and based on the deviation.
